(19) United States
(12) Patent Application Publication
(10) Pub. No.: US 2025/0198757 A1
(43) Pub. Date: Jun. 19, 2025

(54) Method of creating a deviation card after the adjustment of vessel magnetic compass and a system for carrying out this method

(71) Applicant: I-Deviator s.r.o., Ceské Budejovice (CZ)

(72) Inventor: Igor TREGUBENKO, Izmajil (UA)

(21) Appl. No.: 18/985,594

(22) Filed: Dec. 18, 2024

Related U.S. Application Data
(60) Provisional application No. 63/611,796, filed on Dec. 19, 2023.

(51) Int. Cl. G01C 17/38; H04W 4/44

(52) U.S. Cl. CPC G01C 17/38; H04W 4/44

(57) ABSTRACT

The invention is used to adjust vessel magnetic compasses in real time, which is an international obligation to enable vessels to enter ports. The vessel communicates via its vessel communication device (7) with a vessel magnetic compass adjustment system server (1) which provides real-time data to the vessel and which evaluates in real-time the data measured during the vessel's comparison manoeuvre, before and after completing the instructions given by the evaluation software module (6), whereupon it evaluates the compass deviation from the data and issues a deviation card, which serves as a certificate of vessel magnetic compass adjustment.

### FIELD OF TECHNOLOGY

The invention falls within the field of shipping, which uses vessel magnetic compass that need to be periodically adjusted.

### STATE OF THE ART

It is a well-known fact that vessels use magnetic compasses for safety navigation across the seas. The principle of magnetic compass work is in interaction of the magnetized compass needle with the magnetic field of the Earth, therefore whatever the current direction of the vessel at sea, the magnetized needle of the compass points towards the magnetic poles, in layman's terms “north”. This is used in determining and correcting the route of the ship, in case of malfunction vessel's power supply equipment.

Although this is the use of a stable natural phenomenon, it is a common problem that the magnetized compass needle responds simultaneously to other magnetic fields produced by vessel's decks, equipment, cargo etc., causing deviations of the magnetized compass needle-deviation of vessel magnetic compass. Even slight deviations in the determination of true heading causes big problems of not following the route of the vessel at sea or cause danger for navigation.

At present, the above problem is solved by requirement to the vessel's captain to provide proof that the vessel magnetic compass has been always properly adjusted. If this proof is not available, a shore qualified adjuster is called in. The compass adjuster physically arrives on board the vessel and implement procedure of adjustment in process of manoeuvring at the open water. Based on his knowledge of the ship's manoeuvres, after completion procedure he issues corresponding deviation card which ship's captain and his officers use for vessel safety navigation.

However, this well-known process has a number of disadvantages. Firstly, the vessel has to wait its turn to be visited by the adjuster. Secondly, it is costly, time consuming and uneconomical due to necessity of transportation the adjuster from the office to the vessel and back.

An alternative to the above personal adjustment, with expanding of communication technologies, where an alternative solution to the above method has been created and the crew can communicate with the adjuster by email. It means that the adjuster does not physically arrive on board the vessel, thus saving the financial cost and time of transporting him to and from the vessel. In addition, the adjuster can communicate with multiple vessels simultaneously so that the vessel crew do not have to wait for the turn.

On the other hand, the disadvantages of this “remote” method are that the process of detection and calibration vessel magnetic compass deviations is time-consuming. The adjuster first finds out via email communication what vessel magnetic compass is equipped with and some other vessel and equipment details. Then an email with an instruction for manoeuvring and compare true and magnetic headings has to be sent. After implementation of this stage crew sends an email with the data of comparative courses. The adjuster makes required calculations and creates new instructions to change the vessel's headings depending on local variation which is again sent by email. The crew then implements new instructions and sends an email with the new compass and compensating tools data again. Then the process is repeated step by step, with the aim of reduction deviation to acceptable values. Process being prolonged by waiting for individual emails. At the same time such procedure induces consumption of the fuel and vessel time until the adjuster has got sufficient information to issue a deviation card, which he sends by final email to the vessel. New deviation card crew will use for safe navigation of the vessel.

Concerning the term adjustment of the vessel magnetic compass, it is possible to come across alternative names for the same process in professional circles that fall within the above definition. These alternative names for the process include: magnetic compass calibration, compass deviation correction, magnetic deviation adjustment, magnetic compass correction, magnetic compass alignment, deviation elimination in magnetic compass, eliminating compass deviation, magnetic compass deviation error elimination, magnetic compass swing. The term “vessel magnetic compass” refers to the standard compass, a magnetic compass used for navigation, counted in a suitable binnacle containing the required correcting devices and equipped with a suitable azimuth reading device.

The object of the invention is to develop a method of adjustment vessel magnetic compass with further creating a deviation card for use it by crew and ensure safety sailing of vessel. Procedure to be carried out in real-time avoids communication delays as well as economic and environmental negative effects. It is universal across a range of vessel magnetic compass models and is safe and accurate enough. The second task of the invention is to create a system that would enable the implementation of such method.

### SUMMARY OF THE INVENTION

The present problem is solved by creating a method and system for creating a deviation card for vessel magnetic compass according to the invention below.

The object of the invention is achieved by a method of creating a deviation card after adjusting vessel magnetic compass is that it consists of the following sequential steps:
(i)
the vessel communication device establishes a connection with the vessel magnetic compass adjustment system server, (hereinafter referred as “server”)
(ii)
the vessel communication device sends vessel information to the server, it is preferred that the requested information is provided automatically by server if it already exists, or the vessel information is provided by a crew member by manually entering the information into the vessel communication device, which then transmits the information as data to the server,
(iii)
if the server does not recognize the vessel, it creates a request to the vessel communication device to obtain new vessel data and save it in the main database stored on the data storage device. The server generates a request for photo documentation of the vessel magnetic compass, a request for identification of the vessel magnetic compass and a request for sending a copy of the last compass deviation card, which it sends to the vessel communication device to complete the information, which the server then writes into the vessel data in the main database, this information is necessary for the adjustment of the vessel magnetic compass, as it then appears on the deviation card for the identification of the vessel and the vessel magnetic compass,
(iv)
The server sends the vessel magnetic compass-specific documentation to the vessel communication device, containing detailed information about the vessel magnetic compass, its components, and their functions. This documentation will assist the crew in taking further steps as needed. The documentation can be downloaded to the vessel communication device and printed if necessary.
(v)
the server sends a form to the vessel communication device to indicate the current position, number, size of compensation magnets and other means of compass correction. The form includes all possible directions and types of correctors for the specific vessel magnetic compass indicated on the vessel, taking into account the manufacturer, model, possibly year of manufacture and type of vessel magnetic compass. Afterwards, the server waits for a response with the required information from the vessel communication device,
(vi)
the server sends an instruction to the vessel communication device describing the comparison manoeuvre, which is advantageous as it allows the crew to review and prepare for the manoeuvre while ensuring accurate position data can be read from the vessel magnetic compass during its execution,
(vii)
the server sends a form to the vessel communication device to record the collected data during the ship's comparison manoeuvre, this is advantageous in that it does not wait for an email exchange that disrupts the ship's comparison manoeuvre over a long period of time, but the data is entered into the vessel communication device immediately and is sent from the vessel communication device to the server without delay,
(viii)
server uses the evaluation software module to determine the vessel magnetic compass deviation, it is advantageous that all vessel magnetic compass deviation calculations that had to be performed by the adjuster in person, either on the vessel or behind his computer monitor, are automated to speed up the process of adjusting the vessel magnetic compass. In case that vessel magnetic compass adjustment is not required, then step (x) is performed bypassing step (ix),
(ix)
the server generates a multimedia or text instruction for manual adjustment of the vessel magnetic compass by crew members. The crew members reproducing instructions from the vessel communication device, bringing the deviations of the vessel magnetic compass to an optimal value. For the procedure above, the server transmits to the vessel communication device instructions for the adjustment of the vessel magnetic compass with the help of compensation magnets and other available correctors, based on the data from step (v, vii) and offers instructions for repeat comparison manoeuvre and a form for entering the results of these manoeuvres and adjusting. Once again, the evaluation software module is used to determine the compass deviation,
(x)
the server generates a deviation card, based on data transmitted by the crew from the vessel communication device, proposing to download it to the vessel communication device. The advantage of this step is that the vessel's crew can print the document from the vessel communication device or prove their case digitally. The document can also be forwarded to the regulatory authorities. Company management can verify the existence of the deviation card by remotely accessing the vessel magnetic compass adjustment history stored in the main database.

A key advantage of the invention is that all communication within the above process steps is in real time before, during and after the ship's comparison manoeuvre. This means that from the moment the crew decides to undergo the vessel magnetic compass alignment and logs the vessel communication device to the server, everything is done in real time with no delays and thus no wastage of the vessel's fuel. This has a positive effect on exhaust emissions, fuel costs and the speed with which the voyage route is covered.

Further, it is advantageous within the invention that the communication means of the vessel enables the display of a web interface, wherein the server interacts with the crew. The web interface can be designed as a clear user interface that can be intuitively operated without any knowledge of programming, mathematics, etc., so that any responsible member of the vessel crew can operate the vessel communication device projecting the web interface.

It is further advantageous within the invention that during any of invented method's steps, communication is established between the vessel communication device and the communication device of the skilled expert (e.g. certified compass adjuster, IT engineer, etc.). This communication device is further referred as “expert's communication device”. For example, if a problem occurs during the course of adjusting the vessel magnetic compass, the certified compass adjuster will be engaged in the system directly.

Another advantage of the invention is the ability to pause the vessel magnetic compass adjustment procedure and continue from the point of interruption without losing progress. If necessary, the procedure can be continued from another vessel communication device that meets the technical requirements of the invention. For this purpose, the invention has a history of requests from the vessel communication device, both completed and suspended. The invention contains in the main database for each registered vessel a centralized storage of requests (archive of requests, request history), accessible from the vessel communication device upon authorization in the system, where interested party can always view both completed and unfinished procedures for adjusting the vessel magnetic compass.

The invention includes a system for adjusting vessel magnetic compass to perform the above inventive method.

The object of the invention is further achieved by the system is that it consists of a server with at least one data storage device. On the data storage device is stored a main database for keeping a record of the vessels that have used the invented system to adjust their vessel magnetic compass. Further, a database of vessel magnetic compass is stored on the data storage device so that accurate and up-to-date information can be sent back to the vessel for a specific type and year of compass. In addition, a user software module is stored on the data storage device to create a communication interface displayed on the vessel communication device. The user software module will allow a virtual interface to be projected on the vessel communication device that can be operated by a user (crew member) without significant effort. Furthermore, an evaluation software module is stored on the data storage device which, according to the received information on the type of vessel magnetic compass, sends an instruction for a comparison manoeuvre and which determines the deviation of the vessel magnetic compass according to the values measured by the vessel magnetic compass during the comparison manoeuvre. If it is necessary to adjust the vessel magnetic compass settings, then based on these calculations, instructions are provided for vessel magnetic compass adjustments, after which a further check of the result is made by another comparison manoeuvre. Further, the invented system comprises a vessel communication device which is remotely connected for bidirectional communication with the server. The vessel communication device reproduces information and instructions from the server to the crew, and further enables the crew to receive information from on board the vessel and transmit it to the server in the form of data.

The advantages of the system according to the present invention are that instead of lengthy email communication with the adjuster, all communication and evaluation of the vessel magnetic compass deviation takes place, including the issuance of a deviation card after real-time adjustment of the vessel magnetic compass. This leads to time and fuel savings, which also has a positive impact on the environment.

Advantageously, in the context of the invention, an expert's a communication device (e.g. certified compass adjuster, IT engineer, etc) is remotely connected to the server for bidirectional communication. In the event that the vessel crew is unsure of what information to put into the vessel communication device, they can establish the bidirectional communication with a for example remote certified compass adjuster who can assist them in real time with vessel magnetic compass adjustments.

The main advantage of the invention is the creation of a method and system for performing remote adjustment of the vessel magnetic compass that can be handled by any vessel crew whose vessel is equipped with a vessel communication device allowing them to connect to the invented system. The invention responds instantaneously to newly received data from the vessel communication device, and furthermore provides the vessel with up-to-date and accurate vessel magnetic compass documentation at all times, accurate instructions on how to adjust the vessel magnetic compass, and provides authority-recognized documents to allow entry into port, etc. Moreover, the invention will allow contact with for example a certified compass adjuster to be established at any time in order to complete the adjustment without wasting time and fuel.

### CLARIFICATION OF DRAWINGS

The present invention will be explained in more detail in the following drawing, where:

FIG. 1 shows a block diagram of the system for adjustment of the vessel magnetic compass and generation of a new deviation card.

### EXAMPLE OF THE EMBODIMENTS OF AN INVENTION

It is understood that the specific embodiments of the invention described and illustrated below are presented for purposes of illustration and not as a limitation of the invention to the examples provided. Those skilled in the art will find or be able to provide, using routine experimentation, a greater or lesser number of equivalents to the specific embodiments of the invention described herein.

When the need arises to adjust the vessel magnetic compass, for example, the captain sits down at the vessel communication device 7. For example, a desktop computer, a laptop, an on-board computer, a tablet, a smart phone, basically any device that is capable of establishing bidirectional communication with a remote server 1 of the vessel magnetic compass adjustment system via the internet, private satellite connection, etc.

Server 1 initiates a session using the user software module 5, which is projected on the display of the vessel communication device 7. Ideally, the session is conducted in a web interface that can be displayed by any web browser. However, dedicated communication programs that are installed on the vessel communication device 7 are not excluded.

The invention is not limited to browser-based operation as a web interface (like a website or web application) and can be presented in various forms such as: multi-platform software including client software for PCs and laptops, mobile applications for various operating systems, and command-line interfaces. It is also possible to solve the user interface by immersive technology: encompassing VR (Virtual Reality) and AR (Augmented Reality) applications, or for example specialized solutions such as industrial software, automation and embedded systems software. In general, this can be summarized as an arbitrary interface to enable user interaction with the invented system.

The vessel communication device 7 transmits data containing information about the vessel and its authorization credentials to the server 1. Based on this data, the server 1 retrieves and provides information specific to the vessel, if exists, from the main database 3 to the vessel communication device 7. It also allows the entry of new data, which will be saved to the main database 3 for future reference.

The main database 3 contains various data related to the vessel, such as documents and photographs, information about crew members who use the platform on board the vessel, information about the manufacturer and type of the vessel magnetic compass. Last but not least, the vessel data contained in the main database 3 contains the older issued compass deviation cards.

During the main procedure session between the server 1 and the vessel communication device 7, the server 1 sends to the vessel communication device 7 documentation for the specific type and possibly year of vessel magnetic compass that the vessel is equipped with, so that the most up-to-date documentation is present on the vessel in case of need.

And also, the server 1 sends instructions to the vessel communication device 7 on how to execute the comparison navigation manoeuvre to be performed by the vessel, leaving a form projected on the display of the vessel communication device 7 to record the readings to be obtained during the vessel's comparison manoeuvre. These readings can be obtained from gyrocompass, landmark or other device or method known by a person skilled in the art.

Whereupon, server 1 calculates a compass deviation from the received data based on knowledge of the comparison manoeuvre's results, for which it generates instructions for vessel magnetic compass adjustment, if adjusting is necessary.

Instructions for adjusting the vessel magnetic compass are e.g. in the form of text, video, images, audio, augmented reality, etc. They contain everything necessary for a layman to adjust the vessel magnetic compass. The previous steps are then repeated to evaluate the deviation until it is determined that the vessel magnetic compass is correctly adjusted.

After the server 1 transmits to the vessel communication device 7 instructions for a repeat comparison manoeuvre and a form for entering the results of these manoeuvres. After the results analysis, it sends the digital document to the vessel communication device 7, where the digital document can be printed. At the same time, the server 1 stores a process of the procedure and the digital document in the main database 3.

Server 1 maintains communication with the vessel communication device 7 from the start of the session throughout the execution of the comparison manoeuvre for the continuous sending of the collected readings, as well as during the sending of the digital document-deviation card.

During the main session between the server 1 and the vessel communication device 7, it is possible to request the initiation of a secondary session conducted between expert's communication device 8 (such as, for example certified compass adjuster's communication device) and the vessel communication device 7, in the chat interface. The certified compass adjuster will advise on any problem that prevents the successful execution of the vessel magnetic compass adjustment. The certified compass adjuster is available for 24 hours a day, 7 days a week. Other forms of communication e.g. video call, voice call, etc. are also considered.

When the secondary session between expert is communication device 8 and the vessel communication device 7 is requested, server 1 notifies all experts (certified compass adjusters) registered in the system via push, email or internal notifications and the visual interface on the expert's communication device 8. Similarly, when a certified compass adjuster responds to a request, a notification is sent to the vessel communication device 7 and the received response is indicated in the interface. The advantage of this notification system is that it is not necessary for the vessel communication device 7 to be in constant connection with the server 1, or to be in an active session, or to be in the system while waiting for a response.

During the secondary session (whether voice, video communication, or a chat interface is used) between expert is communication device 8 and the vessel communication device 7, it would be possible for both devices 7, 8 to send a file or several files if necessary, which will be saved on data storage device 2 and will be available on any device that meets the technical requirements of the system, even after completing the procedure and transferring it to a centralized storage of requests (e.g. archive of requests, request history).

Audio or video communication data can also be recorded and stored on storage device 2 for later playback when viewing a procedure from a centralized storage of requests, both from the vessel communication device 7 and from expert's communication device 8 (certified compass adjuster) after authorization in the system.

Another advantage of the invention is the ability to pause the adjustment of the vessel magnetic compass and continue from the point of interruption without losing progress. If necessary, the procedure can be continued from another vessel communication device 7 that meets the technical requirements of the invention. For this purpose, the invention has a history of requests from the vessel communication device 7, both completed and suspended. The invention contains a centralized storage of requests (archive of requests, request history), accessible from the vessel communication device 7 upon authorization in the system, where crew can always view both completed and unfinished procedures for adjusting the vessel magnetic compass.

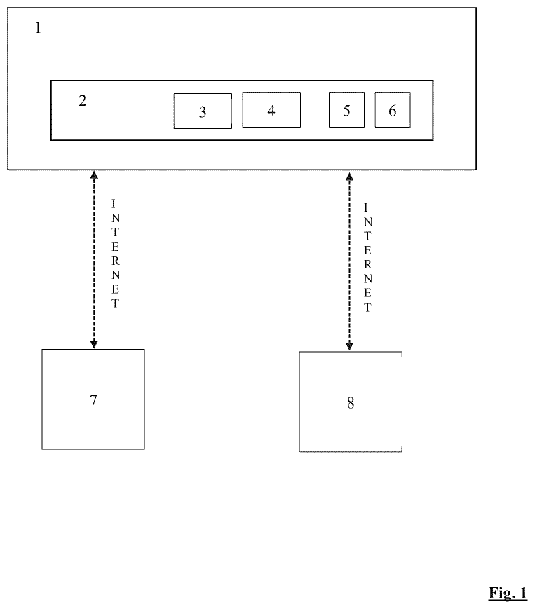

FIG. 1 shows a block diagram of the invented system. The server 1 comprises a server computer and is provided with at least one data storage device 2, e.g. an “SSD” disk. Server 1 is connected to an international computer network via the Internet. Alternatively, the server 1 may be a virtual machine in a cloud environment of a computing power lessor.

On data storage device 2 there is the main database 3, which is divided into the sections of the individual vessels using the system, and a database 4 of vessel magnetic compasses, which includes the current documentation for vessel magnetic compasses of different manufacturers, divided by type and year of manufacture.

Further, the data storage device 2 includes a user software module 5 that allows the server 1 to project a web-based environment that is intuitive and easy to use onto the vessel communication device 7 of the vessel to the user.

And further, an evaluation software module 6 is stored on data storage device 2, which contains algorithms for determining compass deviation from the parameters and results of the comparison ship manoeuvre. The calculation algorithms are in accordance with the methodology of the compass adjusters. At the same time, the evaluation software module 6 includes a program for generating adjustment instructions and for issuing a deviation card showing the results of the current evaluation, inserting certification and identification data into the card.

### INDUSTRIAL APPLICABILITY

The method and system creating a deviation card after the adjustment of vessel magnetic compass according to the invention will find application in maritime industry.

### OVERVIEW OF PICTURE TAGS

1 server
2 data storage device
3 main database
4 compass database
5 user software module
6 evaluation software module
7 vessel communication device
8 expert's communication device

1. The method of creating a deviation card after the adjustment of vessel magnetic compass, characterized in that, it consists of the following procedural steps:
(i) a vessel communication device (7) establishes communication with a vessel magnetic compass adjustment system server (1),
(ii) the vessel communication device (7) sends information about the vessel to the server (1),
(iii) the server (1) shall establish a vessel data in the main database (3), generating a request for vessel magnetic compass photo documentation, a request for vessel magnetic compass identification and a request for a copy of the last compass deviation card for completion in the vessel data in the main database (3), waiting for a response from the vessel communication device (7),
(iv) the server (1) sends to the vessel communication device (7) the compass documentation for the vessel magnetic compass,
(v) the server (1) sends a form to the vessel communication device (7) to indicate the current position, number, size of compensation magnets and other means of vessel magnetic compass correction, waiting for a response from the vessel communication device (7),
(vi) the server (1) sends an instruction to the vessel communication device (7) describing a comparison manoeuvre,
(vii) the server (1) sends to the vessel communication device (7) a form for recording the collected readings during the comparison manoeuvre, waiting for a response from the vessel communication device (7),
(viii) the server (1) determines a vessel magnetic compass deviation using an evaluation software module (6),
(ix) in the case of a compass adjustment is required, the server (1) generate a multimedia or text instructions for manual adjustment of the vessel magnetic compass and sends it to the vessel communication device (7) with instruction to repeat steps (v, vi, vii, viii), in case the vessel magnetic compass adjustment is not necessary step (ix) is skipped and step (x) is continued,
(x) the server (1) generates a deviation card which is sent to the vessel communication device (7) and stored in the vessel's data in the main database (3), with all communication within the above procedure steps taking place in real time.

2. The method according to claim 1, characterized in that, during step (iii) the pre-existing vessel data in the main database (3) is updated.

3. The method according to claim 1, characterized in that, during the progression step (viii), the server (1) generates a multimedia or text instruction for manual adjustment of the vessel magnetic compass by the crew member.

4. The method according to claim 1, characterized in that, the vessel communication device (7) enables the display of the web interface, through which communicates with the server (1).

5. The method according to claim 1, characterized in that, during any one of the process steps, communication is established between the vessel communication device (7) and an expert's communication device (8) through the server (1).

6. The method according to claim 3, characterized in that, is possible to pause adjustment of the vessel magnetic compass and continue from the point of interruption without losing progress.

7. A system for generating a deviation after the adjustment of vessel magnetic compass in the manner according to claim 1, characterized in that, it comprises a server (1) with at least one data storage device (2) on which a main database (3) is stored, further comprising a vessel magnetic compass database (4), a user software module (5), an evaluation software module (6), and a vessel communication device (7) remotely connected for bidirectional communication with the server (1).

8. The system according to claim 7, characterized in that, it comprises and expert is communication device (8) remotely connected to the server (1) for bidirectional communication.
